(19) United States
(12) Patent Application Publication
(10) Pub. No.: US 2021/0025607 A1
(43) Pub. Date: Jan. 28, 2021

(54) AIR EXTRACTION DEVICE FOR PROTECTING PEOPLE FROM POLLUTANT EMISSIONS

(71) Applicant: OSMOSE, Roquefort Les Pins (FR)

(72) Inventors: Pascal TORRES, Roquefort Les Pins (FR); Matthieu MARTINS, Villeneuve-Loubet (FR); Pierre URRUTTI, Antibes (FR)

(73) Assignee: OSMOSE, Roquefort Les Pins (FR)

(21) Appl. No.: 17/041,842

(22) PCT Filed: Mar. 27, 2019
(86) PCT No.: PCT/EP2019/057806

§ 371 Date: Sep. 25, 2020

(30) Foreign Application Priority Data
Mar. 27, 2018 (FR) 1870355

(51) Int. Cl. F24F 9/00; F24F 13/06

(52) U.S. Cl. CPC F24F 9/00; F24F 13/0236; F24F 13/06

(57) ABSTRACT

An air extraction device including suction apparatus having a suction nozzle situated on a box arranged at the rear of a worktop, the suction nozzle being connected to an extraction duct, the device including supply apparatus having a blower fan connected to a fresh air inlet and a supply tube containing at least one supply nozzle provided with an air outlet slot, the air exiting the slot in the form of at least one air curtain directed towards the suction nozzle, the supply tube being situated at the end of an articulated arm. The articulated arm is pivotably mounted such that, when the arm is in a low position, the air curtain separates a breathing area of an operator in front of the worktop from a handling area situated on the worktop, such that the operator's movements do not cross the air curtain.

### TECHNICAL FIELD OF THE INVENTION

The present invention relates to a device for protecting people from potentially harmful gases emitted by the products they handle, and relates in particular to an air extraction device for protecting people from pollutant emissions.

### BACKGROUND ART

There are many workstations where operators must handle products liable to locally release pollutant emissions such as fumes or vapors which may turn out to be toxic. This relates to chemical handling stations such as laboratory benches, weighing, mixing and stirring stations, temporary storage areas, electronic welding stations, workstations requiring the use of harmful products such as glue and solvent, but also production areas. This can also relate to industrial or private kitchens. Air extraction systems designed for workrooms as a whole are unsuitable for localized emissions. There are devices designed to confine toxic fumes in a small enclosure to protect people positioned in front of it. These are, for example, exhaust hoods or extractor hoods comprising an enclosure provided with a removable protective screen so that the operator can handle objects inside and close the enclosure when finished.

A drawback of these devices is that they are heavy, bulky and require high air extraction rates. In addition, these devices offer limited access such that the operator's freedom of movement is restricted. In addition, this dedicated use and this limited access make their use as a common workstation unsuitable or impractical when the suction is not used.

Push-pull type devices make it possible not to oversize the extraction flow rates and to limit energy consumption. They consist of an opening or supply nozzle to blow air and drive vapors or toxic substances towards an opening or suction nozzle. For example, document EP1094280 describes a device for reducing the concentration of harmful substances in the air comprising a fan, an air outlet opening located at the edge of a flat workstation and an air inlet source on the opposite edge and facing towards the air outlet opening. The air inlet source has a tube provided with a series of air inlet openings in the wall of the tube. The drawback of such a device is that the incoming and outgoing flow rates are not accurately adapted according to handling operations in order to optimize the energy consumption of the device while optimally protecting the operators. The device described is imprecise for all use cases. In fact, it is the user himself who places the air inlet source and the air inlet opening for each situation.

There are also devices that diffuse an air curtain so as to isolate an area liable to contain pollutants from a clean air area. The air curtain creates a separation between the volumes of air contained in these two areas so that they do not mix and thus protects the person located in the clean air area. Such a device is described, for example, in the field of kitchen hoods in document WO2004104482. Likewise, document U.S. Pat. No. 6,450,879 describes an air extraction device suitable for kitchens and comprising adjustable supply means. The drawback of these devices is that the air curtain created to isolate the polluted area is necessarily crossed by the arm or the hand of the user when handling the products which are located in the polluted area. The air curtain is then disturbed, air passes from one zone to another and the protection of the person is no longer guaranteed during handling.

### SUMMARY OF THE INVENTION

This is why the aim of the invention is to overcome the aforementioned drawbacks by proposing a device allowing the extraction of substances emitted at an existing workstation, whatever the nature and concentration of the substances, by forming an air curtain not crossed during handling, the device being partly mobile so that the workstation can be freed up.

The object of the invention is thus an air extraction device comprising suction means comprising a suction nozzle situated on a box arranged at the rear of a worktop, the suction nozzle being connected to an extraction duct, the device comprising supply means comprising a blower fan connected to a fresh air inlet fitted with a filter and a supply tube containing at least one supply nozzle provided with an air outlet slot, the air exiting the supply nozzle through the slot in the form of at least one air curtain directed towards the suction nozzle, the supply tube being situated at the end of an articulated arm.

According to the main feature of the invention, the articulated arm is mounted in a pivotable manner on the box such that, when the arm is in a low position, the air curtain separates a breathing space of the operator positioned in front of the worktop from a handling area situated on the worktop, such that the movements of the operator, who is working in the handling area, do not cross the air curtain.

### BRIEF DESCRIPTION OF THE DRAWINGS

The purposes, objects and characteristics of the invention will become more apparent from the following description when taken in conjunction with the accompanying drawings in which:

FIG. 1 represents a general diagram of the device according to the invention in the On position,

FIG. 2 represents a general diagram of the device according to the invention in the Off position,

FIGS. 3a and 3b represent a supply nozzle,

FIGS. 4a and 4b represent a variant of the supply nozzle,

FIG. 5 represents a cross-section of the air curtain,

FIG. 6 represents the suction nozzle,

FIG. 7 represents a block diagram of the device according to the invention,

FIG. 8 represents another embodiment of the device according to the invention,

FIG. 9 represents a second other embodiment of the device according to the invention,

FIG. 10 shows a section of the supply tube according to an embodiment with two supply nozzles,

FIG. 11 represents the supply tube in perspective according to the embodiment with two supply nozzles,

FIG. 12 is a front view of the box according to the embodiment with two supply nozzles,

FIG. 13 is a side view of the box according to the embodiment with two supply nozzles.

### DETAILED DESCRIPTION OF THE INVENTION

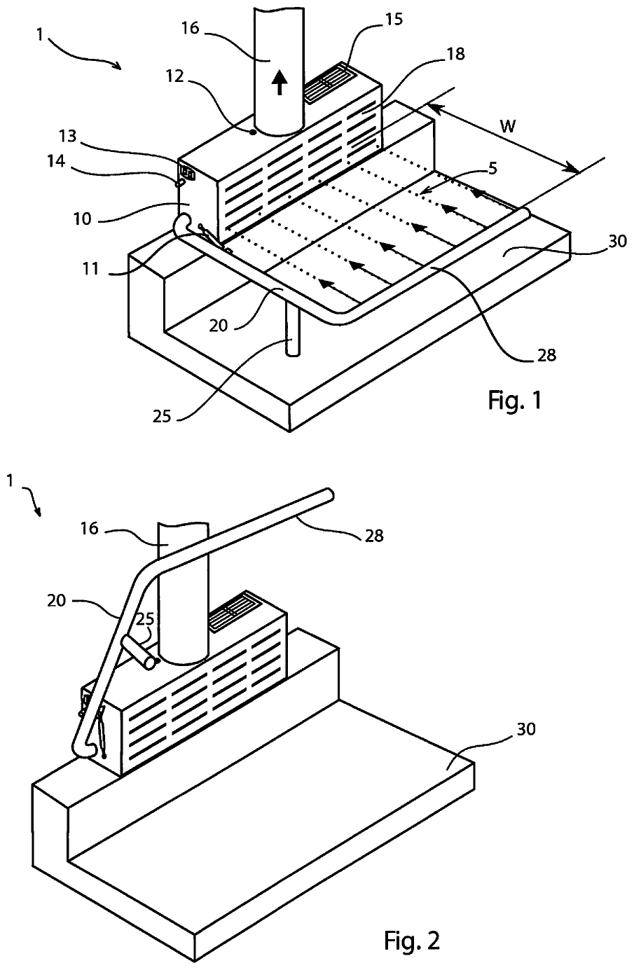

The device 1 according to the invention comprises a box and an arm 20 and is illustrated in FIGS. 1 and 2 according to a preferred embodiment of the invention in which the box 10 is fixed. The arm 20 is pivotally mounted on the box 10 so that it is articulated and movable relative to the box between two positions: a low position illustrated in FIG. 1 and a high position illustrated in FIG. 2. The box 10 is intended to be arranged at the rear of a workstation so as to free up the work surface 30. This workstation can be a chemical product handling station, a welding station, an industrial or private kitchen or any other workstation which requires air renewal and the capture of pollutants to protect people. Inside the box 10 are arranged a suction plenum and a housing which houses the mechanical and electronic parts of the device according to the invention. However, according to an alternative implementation of the device according to the invention, the mechanical and electronic parts are brought together in a housing and remote from the box and connected to it by a duct and a cable. This alternative has the advantage of reducing noise in the room where the box is located and increases the safety of the facility by keeping the electronic parts of the device away from the various products and solvents that are emitted in the room.

The suction plenum opens on the front face of the box onto a flat suction nozzle 18 provided with a set of horizontal slots described in detail with reference to FIGS. 6 and 12. The box comprises at least one extraction duct 16 in which the air entering through the suction nozzle 18 is extracted. The extraction is provided either by the centralized suction system of the room to which the device 1 is connected or by an extraction fan located on the extraction duct. In the case of a centralized extraction system, a connection interface 14 located on the box or on the housing remote from the box, allows the electronic connection between the box and the damper placed on the duct of the centralized suction system in order to pilot its position to control the flow rate, even if the extraction flow rate of the centralized system varies. According to the preferred embodiment of the invention, the fresh air enters through an air inlet located on the box 10, preferably on its rear face or on the remote housing. Alternatively, the air inlet can be connected to a fresh air inlet by a duct. In all cases, the air inlet has a filter 15. The box 10 is connected to the line power by an electrical outlet 13 to be supplied with current and comprises an on/off and alarm indicator light 12.

The arm 20 mainly comprises a bent tube composed of two straight parts, the part of which located at the end has its longitudinal axis parallel to the suction nozzle 18; this part is called the supply tube 28. The arm 20 is connected to the box 10 by an articulated connection so as to be movable relative to the box to pass from its low position to its high position and vice versa. The arm 20 passes from one position to another by the voluntary actuation of a user. The movement of the arm is accompanied thanks to a mechanical means for assisting the movement, such as a hydraulic cylinder 11 which also makes it possible to lock the arm in the high position as illustrated in FIG. 2 so as to prevent it from falling. A blower fan placed in the box 10 or in the remote housing is connected to the fresh air inlet. The air blown by the blower fan is conducted by a flexible duct to the inside of the arm 20 and to the supply tube 28 located at the free end of the arm 20. The supply tube is provided with at least one slot-shaped air outlet so that the air expelled from the supply tube 28 forms at least one air curtain above the worktop 30 directed towards the suction nozzle 18, the air curtain being symbolized by the arrows and the parallel lines 5 in FIG. 1. The flexible duct allows the movement of the arm 20.

The arm 20 also comprises means 25 for maintaining the supply tube 28 at a height above the worktop 30 greater than a minimum height when the arm is in its low position. The minimum height corresponds to the height necessary for the operator positioned in front of the worktop to pass his/her arms under the supply tube 28 of the arm 20, i.e. a height of at least 10 cm. The height of the supply arm relative to the worktop is between 10 cm and 50 cm, and preferably between 15 cm and 20 cm. Therefore, the air curtain is also moved away from the worktop by a height at least equal to the minimum height so that there is a space between the worktop and the air curtain that allows the operator to handle the products and utensils necessary for his/her work without having to cross the air curtain. Indeed, by passing his/her arms under the supply tube 28, he/she handles the products on the worktop below the air curtain.

According to the embodiment illustrated in FIGS. 1 and 2, the supply tube is maintained at a minimum height above the worktop by means of a leg 25. The leg 25 can be interchangeable or telescopic in length between 10 cm and 50 cm.

Advantageously, the arm 20 in the low position of the device according to the invention leaves a space between the air curtain and the worktop not swept by the air flow produced by the air curtain. This space corresponds to a handling area located on the worktop 30. This allows the operator to work in the handling area without disturbing the air curtain, thus while being protected against pollutants emissions from the products he/she handles which are captured before arriving in the operator's breathing space located above the air curtain.

When the arm is in the high position as illustrated in FIG. 2, it is away from the worktop and from the operator so as not to hinder him/her. The worktop 30 is freed up.

The extraction device 1 according to the invention comprises means for operating and stopping the supply and suction means controlled by the position of the arm 20, the stopping of the device being associated with the high position of the arm and the operation of the device being associated with the low position of the arm. These means will be described in detail later in the description.

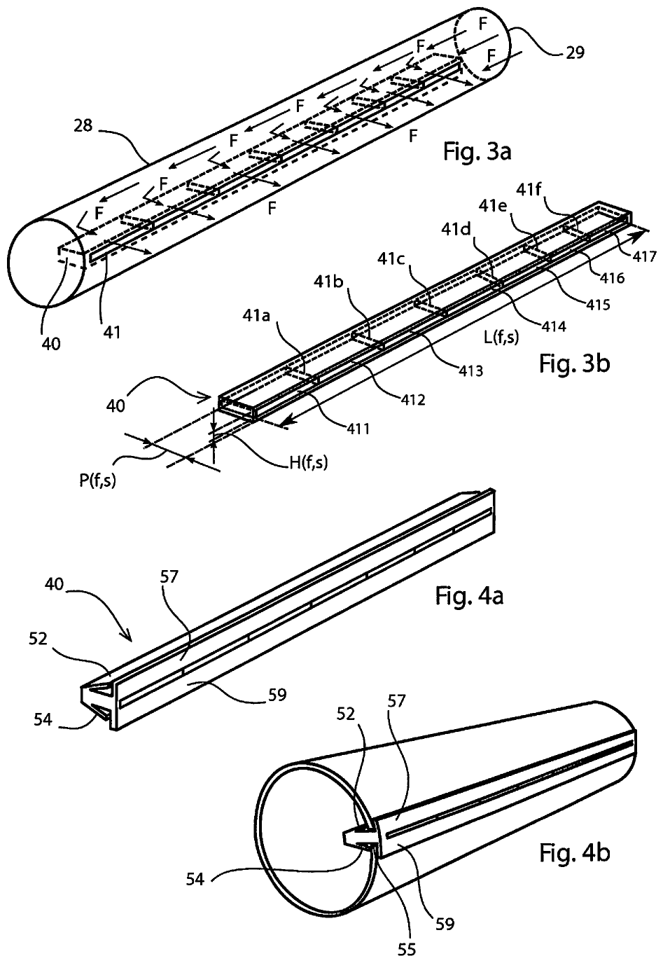

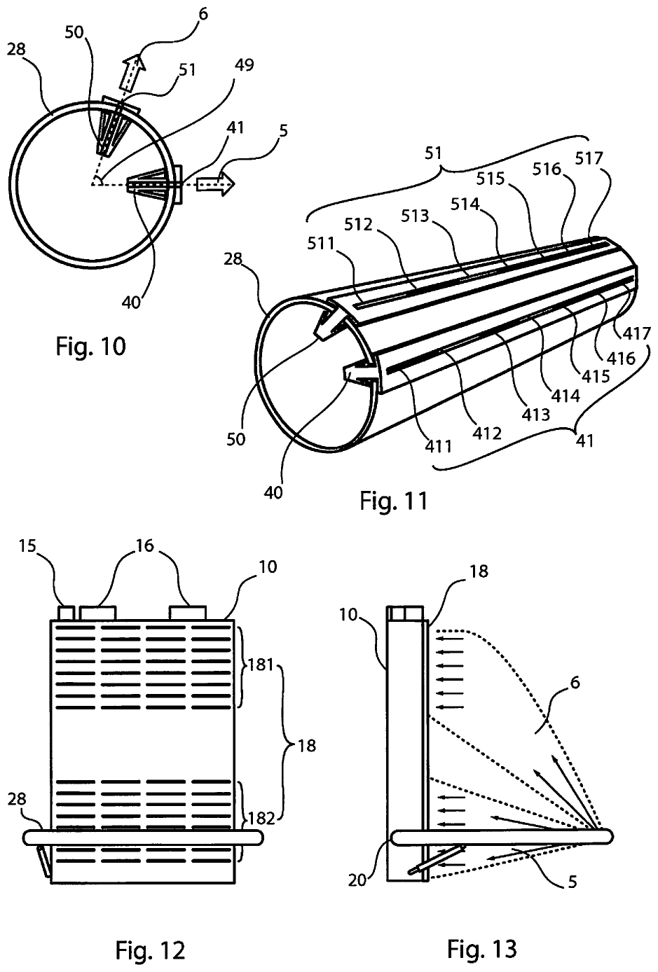

The supply tube 28 is illustrated in detail in FIGS. 3a and 3b. In these figures, the arrows F represent the direction of the air flow. The supply tube 28 has a flow cross section 29 through which the air, coming from the blower fan, enters the tube. The supply tube 28 contains one supply nozzle 40, but can also contain a second one, as illustrated in FIGS. 10 and 11. The air is distributed to the closed end of the supply tube 28, passes through the supply nozzle 40 before exiting through a slot 41 in the wall of the supply tube and forming an air curtain substantially centered on a plane horizontal and above the worktop. In order to orient the outgoing air flow so that it is perpendicular to the supply tube and perpendicular to the suction nozzle, the slot 41 comprises a plurality of fins 41a to 41f over its length, delimiting a plurality of compartments 411 to 417. Preferably, the fins are equidistant and separated by a distance equal to 20 mm while the height of the slot denoted H(f, s) is between 1 mm and 5 mm. The depth of the slot 41 denoted P(f, s) corresponds to the width of the supply nozzle and is between 15 mm and 50 mm. The depth of the slot P(f, s) is proportional to its height H(f, s). The length of the slot 41 denoted L(f, s) corresponds to the width of the air curtain.

The flow cross-sectional area of the air through the slot 41, without taking the fins into account, is sized so as to be between 85% and 95% of the area of the flow cross section 29 of the air entering the supply tube 28 and is preferably equal to 90% of the area of the flow cross section 29. This makes it possible to maintain the pressure inside the supply tube higher than the outside pressure and to obtain a pressure balance in the supply tube 28. Thus, the air velocity at the outlet of the slot 41 is equal over the entire width of the slot and the air curtain is homogeneous.

According to FIGS. 4a and 4b, the supply nozzle comprises means to facilitate its insertion into the supply tube 28 and its replacement by another nozzle. These means are clip-on means such as fins 52 and 54, and retaining means 57 and 59. The nozzle 40 is inserted into a slot 55 of the supply tube 28 until the fins 52 and 54 abut the inner wall of the tube. The fins 57 and 59 are then in abutment against the outer wall of the supply tube so that the nozzle is fixed, as is illustrated in FIG. 4b.

The device according to the invention is sized according to the size of the workstation. In particular, this sizing is carried out as a function of the spacing distance W between the air outlet of the supply tube 28 and the suction nozzle 18 and as a function of the length L(f, s) of the air outlet slot of the suction nozzle of the supply tube 28. Thus, the device according to the invention has the advantage of adapting to any type and size of existing workstations.

In particular, for each device according to the invention, a minimum supply flow rate and a maximum supply flow rate are defined. These flow rates depend on the dimensions of the device and in particular:
the spacing distance W between the air outlet of the supply nozzle 40 of the supply tube 28 and the suction nozzle 18,
the length L(f, s) of the air outlet slot 41 of the supply nozzle 40, and
the height H(f, s) of the slot 41.

The minimum flow rate of the blower fan corresponds to a minimum velocity of the air at the outlet of the supply slot 41 and the maximum flow rate of the blower fan corresponds to a maximum velocity of the air at the outlet of the supply slot 41.

The suction air flow rate is deduced since it depends directly on the flow rate of the blower fan and therefore on the velocity of the air exiting the supply slot 41, on the length L(f, s) and on the height H(f, s) of the supply slot 41.

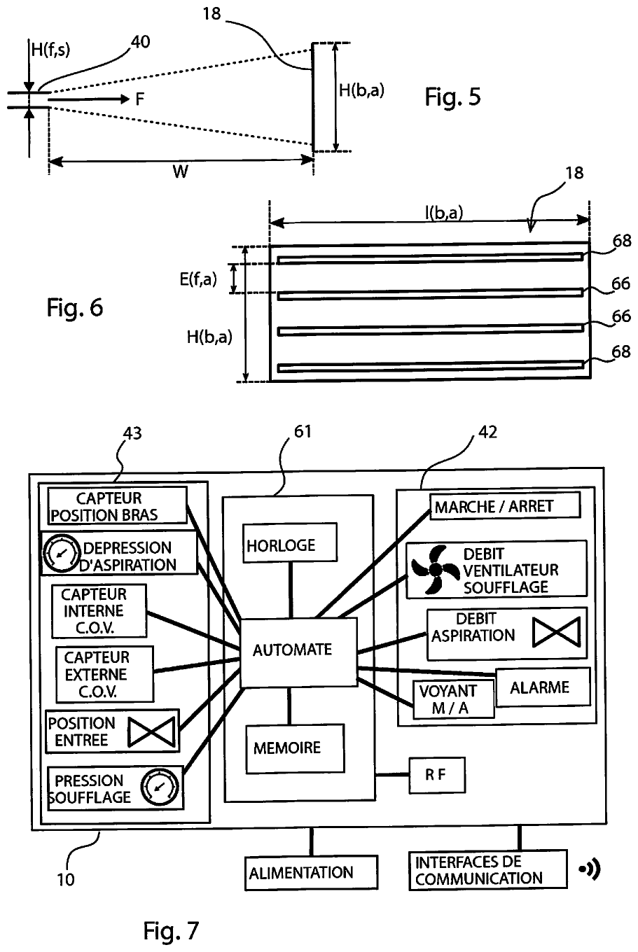

As is illustrated in FIG. 5, the blown air comes out of the supply nozzle 40 in a horizontal jet symbolized by the arrow F but, due to its velocity, drives the surrounding air which is symbolized by the two dotted lines on either side of the arrow F. As a result, the driven or induced air increases the thickness of the air curtain and the quantity of air displaced as a function of the distance traveled. The gas fumes produced by handling and located below the air curtain in the handling area are captured by the moving air flow. The device is sized so that all the air blown by the supply nozzle and the driven (induced) air are drawn in by the suction nozzle.

The suction nozzle is sized according to the calculated suction flow. The suction nozzle comprises at least two horizontal slots 68 parallel to each other and located at the lower and upper edges of the suction nozzle 18 as illustrated in FIG. 6. The width l(b, a) of the suction nozzle is preferably at least equal to the length L(f, s) of the supply slot 41 of the supply nozzle 40.

The height H(b, a) of the suction nozzle is sized according to the height H(f, s) of the supply nozzle 40 and the spacing distance W between the air outlet of the supply nozzle and the suction nozzle 18. Depending on the height H(b, a), the nozzle comprises intermediate slots 66 located between the slots 68. The number of these intermediate slots is adapted to the height H(b, a) of the suction nozzle, knowing that the separation distance E(f, a) between two slots located side by side must not be greater than 50 mm.

Thus, when the two end slots 68 are spaced apart by a distance E(f, a) greater than 50 mm, the suction nozzle comprises at least one intermediate slot 66.

The suction slots 66 and 68 may be continuous as illustrated in FIG. 6 or discontinuous as illustrated in FIGS. 1 and 2 without departing from the scope of the invention. The flow cross-section of the slots being between 88% and 92%, and preferably equal to 90% of the flow cross section of the duct 16, the duct 16 is sized according to the dimensions of the suction nozzle. The reduction of the flow cross section of the slots compared to that of the duct causes a pressure drop which makes it possible to balance the air velocities through the suction slots over the entire width l(b, a) of the nozzle.

According to the diagram in FIG. 7, the box 10 comprises a pilot module 61, a command module 42 and a control module 43. The pilot module includes a programmable controller, a memory and a clock. The pilot module receives input data from the various control units of the control module. This data come from two differential pressure sensors, two volatile organic compound (VOC) sensors, an arm position sensor that detects its high or low position, and the position of the suction damper if the box is connected to a centralized extraction duct. Depending on the values of the input data, the pilot unit sends orders to the various command units of the command module 42. The command units include the on and off modes of the device, the flow rate of the supply fan, the flow rate of the suction and extracted air, an on/off indicator light and an alarm. The various units of the box modules are powered by an external power supply. A communication interface, preferably remote from the box, makes it possible to send communication with the pilot module through a wireless link using a radiofrequency (RF) transceiver.

The first differential pressure sensor is located in the box and measures the pressure difference between the outside and the air contained in the suction plenum of the box 10; the measured value corresponds to the suction vacuum. The second differential pressure sensor is located at the outlet of the blower fan in tube 20. This differential pressure sensor makes it possible, thanks to two pressure measurements along the tube, to deduce the supply pressure and, thanks to the pressure drop coefficient of the tube between the two measurements, the supply flow rate can be deduced therefrom.

The two volatile organic compound (VOC) sensors are used to measure the pollutants contained, on the one hand, in the breathing area and, on the other hand, at the outlet of the supply nozzle 40.

When the air extraction device 1 according to the invention is started, the blower fan starts up so that the supply flow rate is constant and equal to its factory-set minimum setpoint value and so that the minimum velocity of the air in the air curtain is greater than or equal to 0.5 m/s. Indeed, the minimum and maximum values of the supply flow rate, called set point values of the supply flow rate, are stored in the memory of the pilot module.

The target supply flow rate is maintained thanks to the measurement of the supply pressure, even if the filter 15 is clogged. However, when the target flow rate is not reached, the controller of the pilot module 61 sends an alarm signal, for example by illuminating an indicator light 12. Thus, the warning light indicates that either the filter 15 needs to be replaced or a failure on the fan.

The suction flow rate necessary for the correct operation of the device is directly proportional to the supply flow rate according to an algorithm stored in the memory of the pilot module and run by the controller. This algorithm, according to the supply flow rate setpoints, calculates the suction flow rate to be reached so that all the air blown by the supply nozzle and the driven air are drawn in by the suction nozzle.

The suction vacuum is measured and compared to the minimum suction flow rate required. If this flow rate is not reached, the controller of the pilot module 61 sends an alarm signal by illuminating an indicator light 12 indicating a failure of the suction means.

During operation of the device, the suction air flow is regulated by measuring the suction vacuum. For this, the controller acts differently depending on the installation. Indeed, if the air extraction duct is connected to the duct of a centralized air extraction system, the controller controls the position of the suction damper of the centralized extraction duct thanks to an electronic link via a connection interface 14 located on the box and regulates the suction flow rate by varying the position of the suction damper.

If it is not possible to connect the extraction duct to a centralized suction system, the air extraction device according to the invention contains a second fan and, in this case, the controller regulates the suction flow rate of this fan.

On the other hand, the velocity of the air exiting the supply slot 41 is regulated according to the measurement of the VOC sensors which measure a relative pollution between the fresh air expelled by the device and the air located in the operator's breathing space, i.e. the area located above the air curtain. As soon as pollution is detected, the velocity of the air exiting the supply slot is increased so that the air captures and carries the pollutants towards the suction nozzle. The suction flow rate is also increased. When the supply flow rate reaches its maximum value, the minimum air velocity in the air curtain is greater than or equal to 2 m/s.

The On and Off modes of the extraction device according to the invention are slaved to the position of the arm. Thanks to a position sensor located in the arm or at its articulation, an order is given to the controller according to the position of the arm. When the arm is in the high position, the extraction device is off while, when the arm is in the low position, the device is on. The On mode means that supply and suction are working and the Off mode means that they are not working or that they are in the stopping phase.

According to the preferred embodiment of the invention, the On mode is controlled by the controller as soon as the arm begins to move from its high position to its low position, which simultaneously starts the supply and the suction. This allows the nominal flow rate to be established while the arm passes from its high position to its low position. Likewise, as soon as the arm moves to pass from its low position to its high position, the stopping of the device is controlled by the controller. The device can be stopped in two phases: a first shutdown phase during which the blower fan is stopped but during which the suction flow is kept constant and a second shutdown phase which begins at the time T after stopping of the blower fan during which the suction flow is gradually reduced. The time T is calculated as a function of the supply flow rate at the time of stopping and the pollutant concentration measured by the VOC sensors

According to an operating alternative, the device can continue to draw in air when the arm is in the high position, like a conventional hood, drawing in air at a predefined flow rate in order to replace, for example, the air extraction system in the room. Thus, in the high position, the suction flow rate no longer depends on the value of the supply flow rate and is not zero so as to renew the air in the room in which the device is installed. The device begins to operate normally as described in the description when the arm is moved to the low position.

Advantageously, the device according to the invention provides a device whose total or partial stopping associated with the raising of the arm 20 makes it possible to save energy. In addition, stopping being associated with the freeing up of the worktop, the gesture is intuitive.

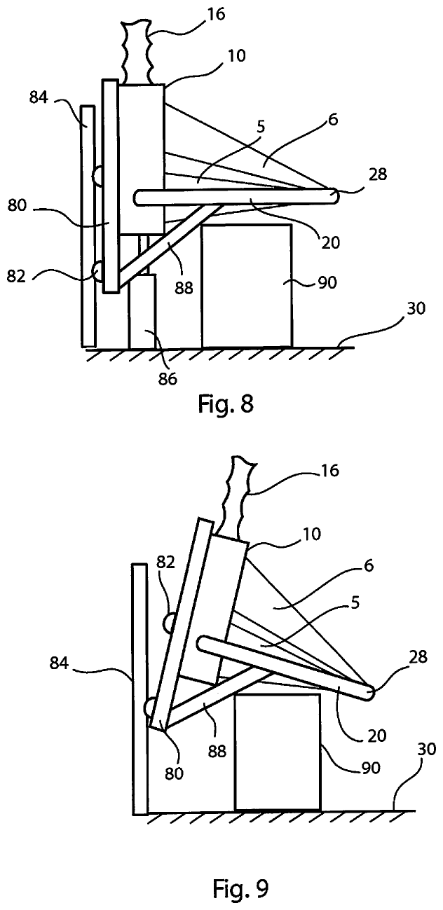

According to another embodiment of the invention, the box 10 is not fixed but movable along guide rails 84 as illustrated in FIGS. 8 and 9. According to this embodiment, the box 10 is fixed to a frame 80 mounted on sliding means 82 along the vertical guide rails 84. The movement of the frame is achieved by means of a mechanical means which can be a cylinder 86 or a pulley or a spring with counterweight. The extraction duct 16 is flexible so as to be able to follow the up and down movements of the box. The box can thus be positioned at different heights along the guide rail depending on the use, for example to adapt to a bulky container of pollutants 90.

According to another embodiment illustrated in FIG. 9, the box 10 is fixed to a tilting frame so as to tilt the box and the arm. Tilting is achieved by mechanical means such as a cylinder not shown in the figure. The position of the supply tube 28 is lower and more ergonomic depending on the uses.

In the two embodiments of FIGS. 8 and 9, the box can be moved manually or by wired or wireless communication. According to a wireless communication mode, a wireless communication interface communicates with the controller of the pilot module by means of a radiofrequency transceiver as illustrated in FIG. 7. In this way, the order requested by the user to raise, lower or tilt the box is transmitted to the controller which controls the mechanical up/down means such as the cylinder 86 and the mechanical tilting means.

According to the embodiments illustrated in FIGS. 8 and 9, the supply tube 28 is maintained at a minimum height above the worktop by means of a support 88. Other means, such as a cable, could be used without departing from the scope of the invention. The main goal being to maintain the supply tube 28 at a height above the worktop greater than a minimum height when the arm is in its low position. The minimum height corresponds to the height necessary for the operator positioned in front of the worktop to pass his/her arms under the supply tube 28 of the arm 20, i.e. a height of at least 10 cm. The height of the supply tube relative to the worktop is between 10 cm and 50 cm, and preferably between 15 cm and 20 cm. Therefore, the air curtain is also moved away from the worktop by a height at least equal to the minimum height so that there is a space between the worktop and the air curtain that allows the operator to handle the products and utensils necessary for his/her work without having to cross the air curtain. Indeed, by passing his/her arms under the supply tube 28, he/she handles the products on the worktop below the air curtain.

The two embodiments illustrated in FIGS. 8 and 9 can be combined so that the box is both tiltable and adjustable in height.

According to an alternative embodiment illustrated in FIGS. 10 to 13, the supply tube 28 comprises a second supply nozzle 50 provided with an air outlet in the form of a slot 51. The air expelled through the slot 41 of the first nozzle forms a first air curtain 5 which is substantially horizontal because it is centered on a horizontal plane as described above, while the air expelled through the second nozzle 50 forms a second air curtain 6 centered on an oblique plane, the angle 49 between the two air outlet slots 41 and 51 being between 60° and 80°, and preferably equal to 70°.

Referring to FIG. 11, the two slots 41 and 51 comprise compartments 411 to 417 and 511 to 517, respectively. As for the slot 41, the compartments of the slot 51 are separated by fins not shown in the figures. The dimensions of the slot 51 and of its fins are identical to those of the slot 41. In order to keep the pressure inside the supply tube higher than the outside pressure and to obtain a balanced pressure in the supply tube 28, the ratio between the flow cross-sectional area of the air through the slots 41 and 51 is maintained between 85% and 95% of the flow cross-sectional area of the air entering the supply tube 28 by blocking every other compartment in the slots 41 and 51. For example, for the slot 41, the even-numbered compartments 412, 414, and 416 are open and allow air to pass and the odd-numbered compartments 411, 413, 415, and 417 are closed, while for the slot 51 the even-numbered compartments 512, 514, and 516 are closed and the odd-numbered compartments 511, 513, 515, and 517 are open and allow air to pass or vice versa. The offset of the open/closed compartments between the two nozzles makes it possible to homogenize the air curtains.

The flow cross-sectional area of the air through the slots 41 and 51, without taking the fins into account, is preferably equal to 90% of the flow cross-sectional area of the air entering the supply tube 28.

The box 10 is shown from the front in FIG. 12. It comprises a suction nozzle 18, at least one air extraction duct 16, an air inlet provided with a filter 15 and the supply tube 28. The box 10 comprises on its front wall a suction nozzle 18 comprising two areas 181 and 182 with suction slots. The box is arranged for example at the rear of a worktop so that the suction nozzle is facing the worktop. The flow cross section of the suction slots of the suction nozzle 18 with two slot areas is twice as large as the flow cross section of the suction slots of the device according to the invention with a single slot area and a single air curtain shown in FIGS. 1, 2, 5 and 6.

In order for the total flow cross section of the suction slots to be between 88% and 92% of the flow cross section of the air extraction duct 16, the flow cross section of the air extraction duct 16 is increased in the case of the device according to the invention with two air curtains. For this, either the diameter of the duct 16 is increased, or a second extraction duct is added.

As is illustrated in FIG. 13, which shows a side view of the box 10, the air exiting through the slots 41 and 51 of the two supply nozzles 40 and 50 located at the end 28 of the articulated arm 20, form two air curtains 5 and 6 directed towards the suction nozzle 18. In particular, the first horizontal air curtain 5 is directed towards the lower area 182 of the suction nozzle 18 while the second oblique air curtain 6 is directed towards the upper area 181 of the suction nozzle 18.

For the device according to the invention with two air curtains, a minimum supply flow rate and a maximum supply flow rate are also defined. These flow rates depend on the dimensions of the device and in particular:
the spacing distance W between the air outlet 41 and 51 of the supply nozzle 40 and 50 of the supply tube 28 and the suction nozzle 18,
the length L(f, s) of the air outlet slot 41 and 51 of the supply nozzle 40 and 50, and
the height H(f, s) of the slot 41 and 51.

This alternative with two air curtains has the advantage that the operator can work with containers or equipment of different heights without the risk of inhaling toxic fumes.

An alternative embodiment of the device according to the invention with one or two air curtains consists in providing the device with a telescopic articulated arm 20 so as to be able to move the supply tube 28 away from the box 10 or closer, depending on the use. A proximity sensor type control device measures the spacing distance W between the air outlet of the supply nozzle and the suction nozzle. This measurement is supplied in real time to the pilot module 61. According to the measured value, the controller of the pilot unit calculates in real time the necessary supply and suction flow rates and sends the instructions to adjust the correct flow rate of the blower fan and the flow rate of the air drawn in and extracted.

1. An air extraction device comprising suction means comprising a suction nozzle (18) located on a box (10) arranged at the rear of a worktop (30), said suction nozzle being connected to at least one air extraction duct (16), said device comprising supply means comprising a blower fan connected to a fresh air inlet provided with a filter (15), the supply means also comprising a supply tube (28) containing at least one supply nozzle (40, 50) provided with an air outlet slot (41, 51), the air exiting said supply nozzle through said slot in the form of at least one air curtain (5, 6) directed towards said suction nozzle (18), said supply tube (28) being located at the end of an articulated arm (20),
characterized in that said articulated arm (20) is pivotally mounted on said box (10) such that, when the arm (20) is in a low position, said at least one air curtain (5, 6) separates a breathing space of the operator positioned in front of the worktop of a handling area located on the worktop (30), so that said at least one air curtain (5, 6) is not crossed by the movements of the operator who is working in the handling area.

2. The device according to claim 1, wherein, when said arm (20) is in a high position, it is moved away from the worktop so as to free up the latter, said device comprising means for operating and stopping the supply or/and suction means slaved to the position of the arm (20), the stopping of the device being associated with the high position of the arm and the operation of the device being associated with the low position of the arm.

3. The device according to claim 2, wherein the device is shut down in two phases: a first shutdown phase during which the blower fan is stopped but during which the suction flow rate is kept constant and a second shutdown phase which occurs at a time T after stopping the blower fan, during which the suction flow rate is gradually reduced.

4. The device according to claim 1, wherein said arm comprises means (25, 88) for maintaining the supply tube (28) at a minimum height above the worktop (30) when the arm (20) is in its low position so that the operator can pass his/her arms under said supply tube, this height being between 10 cm and 50 cm, and preferably between 15 cm and 20 cm.

5. The device according to claim 4, wherein said means for maintaining the arm (20) at a minimum height above the worktop is an interchangeable or telescopic leg (25).

6. The device according to claim 1, wherein the slot (41, 51) of the supply nozzle (40, 50) has a height H(f, s) of between 1 mm and 5 mm and comprises over its length a set of fins (41a to 41f) equidistant from 20 mm.

7. The device according to claim 1, wherein the flow cross-sectional area of the air exiting the outlet slot (41, 51) is between 85% and 95% of the area of the flow cross section (29) of the air entering said supply tube (28), and is preferably equal to 90% of the area of the flow cross section (29).

8. The device according to claim 1, comprising a pilot module (61), a command module (42) and a control module (43), said pilot module comprising a controller, a memory and a clock, said controller controlling the command units of said command module such as the supply and suction flow rates of the supply and suction means, the on and off modes of the device, an on/off indicator light and an alarm, depending on the data received from the control units of said control module (43), the control units of said control module comprising an arm position sensor (20), two differential pressure sensors for the respective measurement of the supply pressure and the suction vacuum, and two volatile organic compound (VOC) sensors for the measurement of the pollutants contained, on the one hand, in the breathing area and, on the other hand, at the outlet of the supply nozzle (40, 50).

9. The device according to claim 8, wherein said extraction duct (16) is connected to the duct of a centralized air extraction system, the controller controls the position of the suction damper of the centralized extraction duct thanks to an electronic link via a connection interface (14) and regulates the suction flow by varying the position of the suction damper.

10. The device according to claim 1, wherein the minimum and maximum supply flow rates, called setpoint values of the supply flow rate, depend on the dimensions of the device according to the invention and in particular on:
the spacing distance W between the air outlet of the supply nozzle (40, 50) of the supply tube (28) and the suction nozzle (18),
the length L(f, s) of the air outlet slot (41, 51) of the supply nozzle (40, 50), and
the height H(f, s) of the slot (41, 51),
the setpoint values of the supply flow rate being recorded in the memory of the pilot module.

11. The device according to claim 10, wherein the supply flow rate is regulated between its setpoint values by means of the pilot module as a function of the values measured by the differential pressure sensors and the VOC sensors so that the air exiting the slot (41, 51) of the supply nozzle (40, 50) captures and drives the pollutants towards the suction nozzle, the minimum air velocity in the air curtain being between 0.5 m/s and 2 m/s.

12. The device according to claim 11, wherein, when the measured supply pressure does not make it possible to reach the minimum setpoint flow rate, the controller of said pilot module (61) sends an alarm signal by illuminating an indicator light (12) indicating that either the filter (15) needs to be replaced or a fault has occurred on the blower fan.

13. The device according to claim 12, wherein, when the arm (20) is in the low position, the suction flow rate is calculated as a function of the supply flow rate according to an algorithm stored in the memory of the pilot module and run by the controller so that all the air blown by the supply nozzle and the driven air are drawn in by the suction nozzle (18), and wherein the suction vacuum is measured and compared to the minimum suction flow rate required, so that the controller of said pilot module (61) sends an alarm signal by illuminating an indicator light (12) in the event of damage to the suction means.

14. The device according to claim 1, wherein the width l(b, a) of the suction nozzle (18) is equal to the length L(b, s) of the supply nozzle, the height H(b, a) of the suction nozzle being sized according to the height H(f, s) of the supply nozzle and the spacing distance W between the air outlet of the supply nozzle (40) and the suction nozzle (18), said suction nozzle comprising two suction slots (68) located at the lower and upper edges of the suction nozzle (18), said suction nozzle comprising a suitable number of intermediate slots (66) located between the two slots (68) as a function of the height H(b, a) of the suction nozzle, knowing that the separation distance E(f, a) between two slots located side by side must not be greater than 50 mm, the total flow cross section of the suction slots being between 88% and 92% of the flow cross section of the extraction duct (16).

15. The device according to claim 1, wherein the box (10) is fixed to a frame (80) sliding on vertical guide rails (84) by means of sliding means (82) so as to adapt to a bulky container (90) placed on the worktop (30).

16. The device according to claim 1, wherein the box is fixed to a tilting frame by means of mechanical tilting means.

17. The device according to claim 1, wherein the supply nozzle (41) has a plurality of compartments (411 to 417), one in two being open while the supply nozzle (51) comprises a plurality of compartments (511 to 517), one in two being closed.

18. The device according to claim 1, wherein the two air outlet slots 41 and form between them an angle 49 of between 60° and 80°, and preferably equal to 70°.

19. The device according to claim 1, wherein said articulated arm (20) is telescopic so as to be able to move said supply tube (28) away from or nearer to said box (10), the spacing distance W between said air outlet of said supply nozzle and said suction nozzle is measured by a sensor and supplied to said pilot module (61) so that the controller of said pilot unit calculates in real time the necessary supply and suction flow rates and sends the instructions for adjusting the correct flow rate of the blower fan and the flow rate of the suction and extracted air.
